(19) United States
(12) Patent Application Publication
(10) Pub. No.: US 2006/0288205 A1
(43) Pub. Date: Dec. 21, 2006

(54) Administration development of digitally encrypted archives

(76) Inventor: Enrique Urdaneta Linares, Caracas (VE)

Correspondence Address: MERCHANT & GOULD PC, P.O. BOX 2903, MINNEAPOLIS, MN, 55402-0903, US

(21) Appl. No.: 11/023,061

(22) Filed: Sep. 20, 2005

(30) Foreign Application Priority Data
Dec. 31, 2003 (VE) 00321-2003

(51) Int. Cl. H04L 9/00

(52) U.S. Cl. 713/165

(57) ABSTRACT

A system for creating and controlling electronic serial decoders or keys (private and public) permitting the commercialization and exchange of digital archives and secondary storage devices with high interactive multimedia content are disclosed. These electronic serials, which are obtained by a Single External Server (SES), carry out the control and actualization between registered users that are properly authenticated to the server. Once authorized, registered and authenticated, the user within the SES activates the port of the electronic serial or key (public) in the client-computer. In a client application, a standalone process called the CONTROLLER, processes the electronic serials (public and private). In this manner, the application authorizes a digital archive contained in a secondary storage device.

### SUMMARY OF THE INVENTION

The objective of the above referenced invention is to establish a compound system for local and distributed applications. The local and distributed information applications will carryout the processes of creation and control of electronic serial decoders or keys (private and public) permitting the commercialization and exchange of digital archives (with and without rights of the author, patents and marks, among others) and secondary storage devices with high interactive multimedia content. These electronic serials, which are obtained by a Single External Server (SES), carry-out the control and actualization between registered users that are properly authentic to the server.

Once authorized, registered and authenticated, the user within the SES activates the port of the electronic serial or key (public) in the client-computer. In a client application, a standalone process called the CONTROLLER, processes the electronic serials (public and private). In this manner, the application authorizes a digital archive contained in a DAS. The registered may can carry-out the commercial development of the digital archives between the user and the SES or between users who are properly authenticated and registered. The commercialization or exchange of the digital archives is carried out across electronic serials or keys (public) with intervention of the SES. Moreover, it can count as many applications as in the client-computer, like mobile-client, that the transaction permits. The advantage the electronic serials offer is that they grant maximum legal protection to the digital archive. In this way, it conserves the custody and reserves of the rights of the author, patent and mark, among others in the case of the request.

The field to which the invention applies is that of Information, specifically, multimedia technologies and Internet.

### PRIOR TECHNOLOGIES

The Internet and the World Wide Web are at vast proportions of accessible multimedia information for the marketing across Web servers. In the beginning, encryption technology carried-out among difficult and complete transference mechanisms of archives across protocols ftp, http and others. Ultimately, the tendency of the algorithms of encryption is based in the placing of the public and private keys which permit decentralization of the components of security that alter the protected archives.

The speed of Internet connections may be adversly affected when there is high traffic volume, and can result in lengthy response time. Diverse proposals have been suggested at the international level to expand the limits of Broad Band to address the issue. It is this struggle that the focus of the transference of digital content that are carried-out in the manner of distribution. For example, the utilization of outlying storage devices to maintain great volumes of digital content. Security mechanisms and encryption may also be applied to these great volumes of digital content, but these tools are currently only valid across a centralized system. Under this context, a Web Server should be able to have total access to authentic activation codes. Which translate the content that the users have in the outlying storage device intended for utilization to which access is initiated.

[image]

[image]

[image]

### DESCRIPTION OF THE INVENTION

1. Constructive Application of Electronic Serials or Keys Associated to Digital Archives (CREATOR):

1.1. Creation of Digital Archives

The CREATOR has the capacity to produce a catalog of digital archives. Each one of these digital archives is encrypted and stored in DAS. At the same time, each archive is assigned a specific extension in a compressed (ZIP) directory and the SES is informed of the electronic serials or public keys that permit the decoding the digital archives.

1.2. Creation of Electronic Serials

There may exist other archives that are databases, which contain the attributes of each digital archive will be marketed. From this form, each time a DAS is loaded in the controlled application all of the information associated with the digital archives is loaded into memory at a determined variable. Each digital archive is encrypted with keys of a predetermined quantity of bits. These keys or passwords are generated randomly by a mathematical function of the created application. In relating the format of the keys and electronic serials, a user has a gropu of keys for each DAS that serve to decode the archives of that particular DAS. The keys are stored in a specific archive inside a directory associated with DAS.
A possible scenario:
   Each archive contains n lines, where each line contains a serial used to decode a digital archive. The entire serial occupies 216 bytes distributed in the following manner:
1—Key/Password to decode a digital archive (16/128 bits).
2—Login of the user (64 bytes). The login concludes with the sequence of the character/ to complete the 64 bytes, in case it is necessary.
3—Identification of the request of the digital archive in the system (16 bytes): This concludes with a sequence of character/ to complete the 16 bytes, in case it would be necessary.
4—Identifier of the digital archive in the system (16 bytes): This concludes with a sequence of character/ to complete the 16 bytes, in case it would be necessary.
5—Identifier of the DAS (64 bytes): This concludes with a sequence of character/ to complete the 64 bytes, in case it would be necessary.
6—Number of the digital archive (4 bytes): This concludes with a sequence of character/ to complete the 4 bytes, in case it would be necessary.
7—Initial byte of the digital archive (16 bytes). This completes with a sequence of character/ to complete the 16 bytes, in concludes it would be necessary.
8—Quantity of bytes that occupy the digital archive (16 bytes): This concludes with a sequence of character/ to complete the 16 bytes, in case it would be necessary.
9—Group to which belongs the digital archive (4 bytes): This concludes with a sequence of character/ to complete the 4 bytes, in case that it would be necessary.
   1.3. Creation of the Structure of the Directories

There may be an archive, which is strongly encrypted and processes the information for the user that has the specific data of this DAS. For each user there is a display of listed themes that possess information (since the last synchronization) related to the DAS that were loaded. The user could display the state of the themes (which archives can be executed and which can not). All the content of these are encountered in the DAS, which is necessary to enable this device to display the digital archives or the informational themes in particular.

1.4 Creation of a DAS

Once the multimedia material is prepared and/or the dynamic contents that are displayed across the digital archives are decoded, construction of the DAS can begin.

Hierarchy directory structure and location of the archives are relevant in this invention. The application (controller) is installed as a default in the client-computer in an associated directory. This directory should contain the executable archive of installation, which should include the following subdirectories:

info: This directory contains the personalized information of each DAS that was carried out in the local computer. This directory has a connection with subdirectories whose name is equal to the serial of the DAS. Each subdirectory of users would have:
A created archive for the addition of a new DAS. It serves to identify the user name, description and specific properties of the information therein.
An image.
An archive that contains the information and base of access used to optimize the functionality of the system. This information is strongly encrypted with a password. The decoded information has the following format:
<header>:=Login SERIALOF THEDEVICE
{<Quantity of times that appears the digital archive appears I>}
An archive that contains the keys that decode the digital archives.

This information is strongly encrypted with a password.
Directories that contain control archives of the ultimate actualization of the information contained in the digital archives.

images: this directory contains images and components of static animation.

There exist some binary archives that contain all of the encrypted digital archives. A digital archive is an archive under a specific technology, which was encrypted and applied in one of the binary archives. These archives do not have a header. Without a utility, the binary archives cannot be opened.

1.5. Actualization of the Information of a DAS in the SES

Once the user is properly registered and authenticated with the SES, the user has the option to synchronize to the relevant DAS and administer permissions on local access. The SES should coordinate the process and authentication of the data that it encounters remotely and locally to the user. The accessibility form will be used to register users and will be centrally stored.

2. Single External Server (SES)

2.1. Enrollment and Registration of Users

One of the actions that the user may carryout under the client-computer should be properly registering and authenticating within the SES. The user should fill in the blanks on the form with their personal information.

2.1.1. Methodology of Payment (Authorization of Use)

The user should register a form of payment for accessing the digital archives in the SES.

This will permit control of the profile of user within the SES, and carryout the steps of payment in the most sensible and simple manner as possible. Theses forms of payment can be prepaid systems of money or a direct form of payment via online systems against capital deposits or credit cards.

In certain cases they can give conditions that the registered user would only need the authorization of the SES and would not require any manner of payment. Quickly these business relationships can develop within a business or company. This form of archive management can be carried out free of charge for those users.

2.2. Register of DAS

Once the user completes registration he/she can process the direct registration of a catalog of archives within the SES. This registration process is within the client-computer and across the controlled application. The application can have one or more previously registered catalogs. The properly authenticated user within the SES should input a serial of the register of the DAS, which would be evaluated by the SES and subsequently registered under this user's profile. This user could utilize the DAS in as many computers as the client wishes. This anticipates synchronization across the SES—of the information from this DAS in particular.

2.3. Commercialization User—SES

Once registration has taken place, the user may start the first transaction with as few as one local application. For example, the archives of serials which are necessary to secure the following transactions of digital archives between the proper user and the SES.

2.4. Commercialization User—User

2.4.1. SES

The SES is the entity that carries-out the principal functions of interchange transactions between two users who carryout a private conversation inside of the interactive application or across cordless devices connected to the client-computer. This function is what directs processing of the interchange in the database of registered users. It also permits the database to carryout the synchronizations in the different client interfaces (Controlled Applications). The power to visualize the content of the digital archives comes from the DAS.

This function has two models. One model is for the users of the properly said interactive application. The other model is for the administrator of the same.

The primary model permits authorized users to meet in a conversation room, “chat room”, to exchange messages in real time with other similar user-types. As well as to carryout operations like publishing an offer or requesting a digital archive in order to carryout interchange transactions with other users. The service of this interactive model is based on a Client/Server architecture where part of the client displays itself across an Internet browser on a Web page to permit the interaction of the user with the said interactive application (such as to send and receive messages, to see the list of registered users on line with the SES, among others). The SES acts as an application that is perpetually on call, waiting for connections of new registered users. When a new user makes the request to enter the chat room the SES creates a new application of the same with the data indicated. After that, the new user can begin to interact with the other registered users.

In contrast, the second model is employed for authorized users to update the information associated with the conversation rooms available for the interactive application. This may include adding, creating, modifing and eliminating conversation rooms.

An instance of the process is created and activated every time a registered user makes a request to connect with the SES and when the request is accepted. This model will end the process of capturing, processing and sending messages. Each received message represents a petition of the registered user for the process to execute the acceptable methods. Within these principal methods we possess the following functions:
Authentication of the registered user
Send messages
Transaction of interchange

The registered user who desires to initiate a session in the interactive application within the determined room can do this in two ways. The registered user could be an anonymous user (who can only send messages to the rest of the users in the room), indicating a nickname. The other option is when registered user, indicates their login and password. In this case, he/she can carryout a process of authentication.

The authentication process consists of validating that the user who filled out the initial petition of session is registered in the SES. An authenticated user can carryout more operations than an invited user, within the options. An authenticated user may start up a private conversation with another user who has entered the room may request and offer digital archives and carryout transactions of interchange, among others.

To carryout the authentication process, the user connects through an external server via a URL under a secure connection. The page invoked is what is responsible to carryout as many transactions and indicate the result of the same. In requesting to go to the desired page, the user should provide all the parameters required for authentication. The parameters may include login, password and the room where he/she wishes to enter.

2.4.2. Mobile Devices

This invention solves the problem of the interchange of these electronic serials. This interchange would be across the interactive application of the single external server (SES). It could also exist across a wireless device, which previously contained a connection interface with the SES. The interface can directly process the transaction of the serials between the users, or, it can establish a prior code that confirms that the electronic serial has been transferred to another registered user. This would not be effective until multiple unsynchronized devices within the SES process the transaction and carry it out properly. For instance, when both users who wish to carryout an exchange possess the identification codes of exchange of serials or when one of the users accepts a request for the guarantee by the SES. Many of the prior codes, like the options of requests, can stay stored in any Mobile or wireless device. These devices should contain a digital memory predetermined for the specific manufacturer of the device and an operating system that can permit (depending upon the device) the installation of an application that processes the communication with the SES. These devices exist to control the information that has been communicated by the exchange. These specific devices can be a mobile or cellular telephone, which is connected via WAP, UMTS, GPRS or across a service such as SMS or MMS.

The wireless devices should be connected to the client-computer to be able to use the power of the information of electronic commercial serials. These devices can be mobile telephones, PDA, Palm Pilots, etc.

2.4.3. Physical Transaction

The user should solicit a serial through the SES, which can display the effects of the process, the physical exchange, to another user.

Across this function, the user would be able to carryout the positioning of the serial exchange across the SES directly. In other words, the SES portion of an interface where the user may register and authenticate so he/she can provide the code of the digital archive serial exchange to another user. The one time user would await confirmation within the SES. The one-time user that carries out the exchange would be introduced to his/her new exchange serial by the original user. This is what could be called a camera of compensation of serials under which the SES receives requests of serial exchange. Also, this waits for the request of the other user, which it accepts. The effective exchange of operation can have an approximate wait time of 24 hours. If during this time no connection is established, the second serial controls the exchange. Then the validation of the original transaction is cancelled.

2.5. Synchronization of General Information

Utilizing this function, the user can download information of interest across the SES. The user can also keep up-to-date on the controlled application of digital archives contained in the registered catalogs of the user.

3. Controlled Application of the Digital Archives and Electronic Serials (CONTROLLER)

3.1. Installation of the Controller

The user carries out the installation of the controlled application in his/her local computer. This controlled application manipulates catalogs of digital archives. It also processes the management of serials across the SES, proportionately within directory structure. This organizes the information of interest of each registered DAS in the local computer.

3.2. User Authentication

3.2.1. First Time

DAS contains electronic archives of a specific theme. To be able to reproduce of some of these archives the user should process the initiation within the SES. This should be processed under registered and authenticated terms in order to grant the first serials to be discharged for the controlled application. These previously were commercialized and/or exchanged before the SES or some other registered user.

3.2.2. More Than One Time

To access the informational content of the archives, the user may process the electronic serial downloaded from the SES. The transparent authentication process that occurs as a result of the above procedure facilitates the access of the archives. This occurs although there may exist a difference in the system of downloading encrypted content via the Web. Avoiding the downloading of these, the SES will then direct itself to bring an update of a panel of administration of serials and an historical register of users, signed under a group of serials that were processed under the models of exchange, commercialization or other business models of serials associated to the system of this invention. The registered user should indicate his/her session in the SES to be able to acquire new serials from the server and to be able to process the commercialization and exchange.

3.3. Authentication of the DAS

Once installed, the controlled application can process the register of countless DAS. Under prior approval of the SES, the DAS forms part of the structure of archives that the controlled application should be able to manage for the utilization in the local computer of the digitally encrypted archives. Each DAS can authenticate itself in different local computers. In the local computers they will create a structure of identity directories and stay updated across the respective synchronization.

3.4. Marketing User—SES

The user will be able to endlessly market, within the SES, the electronic serials referred to in the DAS that possess them. Once serials are in the SES, the user will have stored in the client-computer a group of electronic serials. These serials permit execution of the digital archives positioned in the DAS. They also direct the decoding of the information contained in the archives for its accurate reproduction.

3.5. Marketing User—User

3.5.1. SES

The registered user can market or exchange the electronic serials that he/she has with other registered users of the SES. They can process online with the SES, across an interactive application, which has the function to provide information with users who can communicate amongst themselves. The users can strike up conversations and discuss common interests in real time. It follows that the users can also send messages and receive responses immediately. The service that provides the model that has the particular permit to the registered users in the SES to process the exchange of digital archives and request and offer some of the same archives under registration online by means of the SES.

3.5.2. Mobile Devices

The user can store in the client-computer as many local applications as mobile-client applications transmit information to the application controller.

3.5.3. Physical Transaction

3.6. Synchronization of the General Information

3.7. Visualization of Categories and Digital Archives

Once the first synchronization is processed, the user should enter his/her login and password for accessing the system. The secret is that the encrypted keys contain the login, password and identifier of the DAS user. The verification that decides if the password is correct happens rapidly if the decode contains the login and password introduced for each user and coincides exactly.

The controlled application accesses the DAS and permits the display of all the content of the digitally encrypted archives, which the electronic serials decode (public) download. These also connect perfectly with the stored electronic serials (private) in the DAS. In this manner, the user can visualize the content without the necessity of continuous connection with the SES.

The application of controlled content, inside of a simple platform and expandable development within the SES (of global access) the authorization, reproduction, marketing and exchange of electronic serials or keys that control the informative display of the digital archives in the client-computer of the registered user.

In relation to the presented invention one should understand the following basic operations:
Exchange, sale and marketing of electronic serials of access.
Generation and acquisition of Interpretation Codes on behalf of the final users, these codes have the finality of decoding the digitally encrypted archives.
System of registration of operational transactions with electronic serials, among registered users.
Data Base of authorized clients and registered users in the system.
Control and Marketing of electronic processes of serial transmission.
(Local) Application of (local) Control and interface of reproduction of archives in the client-computer. (Controlled Application)
Administration and Marketing of operations of electronic commerce concerning obtained serials.
Operations of administration of the user data and of the internal operational information:
   Login and passwords of the final registered users.
   Numerical serials assigned to the peripheral secondary of memory.
   Codes of encryption and decode for the digital archives.
   Online management of electronic serials associated with those that permit to decode the digital archives.
   Historical Register of statistics of the registered users.
   Historical Register of commercial transactions.
   Historical Register of exchange of electronic serials.
      Technical Specifications
Minimal Connections, Time of response,
Time of response+Minimal Connections,
Round Robin, Distribution of the Upload.
TCP, UDP, SSL, FTP, Telnet, SMPT,
HTTP, IMAP4, LDAP, NNTP, POP3, DNS,
Bootp, TFTP, SNMP
Interfaces of Integrated Online Command
GUI based in Web, Telenet, SNMP, RMON,
Windows NT, Server and XP.
For programming of support applications:
Java
Java Server Pages
Visual C++
Visual Basic
PHP
ANSI
XML-Html
JavaScript
Flash MX
Database
MySQL
ISP Connectivity
802.3 10 BaseT, 802.3u
100Base TX, 100BaseFX, 802.3z 1000 Base
SX, 802.3z 1000 BaseLX, 802.3 Flow
Control, 802.1q VLAN Tagging, 802.1d
Brodging, 802.3 Ethernet Like MIB,
Repeater MIB, Ethernet Interface MIB,
SNMP V1, SNMP MIB II
   Technical Glossary.

User: Person who carries-out interactive activates in front of a computer, which has certain processes of control in front of a distribution system of computers.

Client-Server: Distribution System of computers that serve as information authenticates the client who solicits and receives information. The server uploads to process the solicitations of the clients.

Digital Archives: Association of data that can contain the following information: images, hypertext, sounds, documents and/or multimedia, among others, with and without rights of the author, copyrights, trademarks.

Catalog of Digital Archives: Collection of graphic interfaces that contain descriptive elements of navigation and operability or treatment of digital archives.

Electronic Serial Keys: They are defined as the access keys that permit to encode and decode digital archives with the objective of extending major privacy and security to the electronic serials utilized in the encryption of public key, which divides onto Public Keys and Private Keys. For a digital archive, the wish to reproduce it should count with the public key, to be able to utilize the private key. It can decode this. The system of public keys has the following advantages: a) it is very secure that the keys are sufficiently large (at least under 128 bits) b) for each user only one pair of keys is necessary, and c) the public key of a user can—and should—be published.

Devices of Secondary Storage (DAS): They are defined by outlying unities of storage in the client-computer of the user. These unities can be: CD, DVD, ZIP, I-PILOT, etc., which should contain the following:
Structure of directories that contain a group of electronic serials or private keys.
The encrypted digital archives (with electronic serials or private keys). Which contain access to images, dynamic connections to Internet, animations, directory of multimedia content, documents and sound archives, among others.
A controlled, self-stabilizing application. A resident application in the client-computer that permits the unloading of public keys marketable and/or exchangeable and the visualization of the catalogs of digital archives.

Single External Server (SES): Computer that performs, like the server, under the scheme Client-Server. It directs the registration and authentication of the users. It also processes the granting, authentication and synchronization of keys or electronic serials (public), marketable and/or exchangeable between user-SES or within user-user. This processes across an interactive application that permits the communication of the users across channels of messengers where they can establish all of the transactions that would be serial-serial or serial-values.

Constructive Application of Electronic Serials or Public and Private Keys

(CONTROLLER): This is an informational application of internal administration, which directs the producing of the public keys and assigning them to the SES. This is much the same as producing the private keys and the digitally encrypted archives with said keys, and introducing them into DAS in agreement with the formula of known encryption of both keys. They also should process the access registers. These permit the transference of the digital archive routines that contain visually associated routes to the catalogs of digital archives.

Standalone Application: Informational program in which installation within a computer-client is carried-out.

Controller Application of digital archives and electronic serials (CONTROLLER): Standalone application functions independently in the client-computer and frequently synchronizes itself with the SES, to authenticate the information of the users, of the application in C and of the commercialized electronic serials and/or exchanges. To enter this program the user will encounter an authentication screen. The process of authentication refers to the name of the user and password. If these are correct, then the related information of all of the DAS that were registered for the user in the client-computer will appear. This is displayed in the form of an interface of rapid access to the catalogs of registered digital archives.

1. A system to permit the commercial exchange of digitally encrypted archives, stored in secondary storage devices (DAS), across electronic serial decoders obtained by a single external server (SES).
Wherein:
a) To establish a system comprised of local informational applications and distributions that carryout the processes of creation, control and management of electronic serials or keys (public and private) to permit the marketing and exchange of digital archives across the Internet.
b) To operate within methods of mobile wireless storage, which permit processing of the management of keys coded between an SES and a local application which process the opening, marketing and exchange of many protected digital archives.
c) To increase the level of security and rate within the opening process of digital archives, which encounter storages in devices of secondary storage (DAS).
Where:
i) The system processed in the commercial exchange between registered users, and who should be authenticated within the SES, have decode keys of digital archives from the Internet within the local computer that possesses the DAS. This permits the management of the archives that are introduced locally to the computer. These access rapid execution completion of authorization permission, obtaining a secure system and rapid to process digital archives that are wished to have protection. It is to say that they have restricted access and that only under the process of keys that download across the Internet by method of a SES, it produces the execution or visualization of such archives.
ii) The system protects the encrypted keys containing secret data of identification and access to DAS and of the user. The verification of these data decides if the access to the digital archive is or is not valid. In this manner, the user can visualize the content without the necessity of a continual connection with the SES.
iii) The system provides a controlled application of the content and a server of world access, across of which generates the authorization, reproduction, marketing and exchange of electronic serials or keys that control the informative display of the digital archives and the computer-client of the registered user.
iv) The system controls the authorization, registration, and authentication of the user before the SES, for to carryout downloading of the electronic serials or keys (public) in the computer-client and permit the commercial management or the access to a digital archive contained in DAS.

2. A method for permitting the commercial exchange of digitally encrypted archives stored in secondary storage devices (DAS) across electronic serial decoders obtained by a single external server (SES), the method comprising:
a) establishing a system comprised of local information applications that carry out the processes of creation, control and management of electronic keys, the keys being both public and private, which permit the marketing and exchange of digital archives across the Internet;
b) establishing registered users to be authenticated within the SES with decode keys for digital archives stored within the local computer that possesses the DAS, wherein the archives are introduced locally to the computer, wherein the registered users have restricted access and that only under the process of the keys that download across the Internet by method of a SES is the execution or visualization of the archives permitted; and
c) permitting access to the registered users by deciding if the requested access to the digital archive is or is not valid, wherein the registered user can visualize the content without the necessity of a continual connection with the SES.
